(19) United States
(12) Patent Application Publication
(10) Pub. No.: US 2009/0316108 A1
(43) Pub. Date: Dec. 24, 2009

(54) EYEGLASS WITH ELASTIC ELEMENT

(76) Inventor: Hsing-Jen Lee, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/237,850

(22) Filed: Sep. 25, 2008

(30) Foreign Application Priority Data
Jun. 19, 2008 (TW) 097122936

(51) Int. Cl. G02C 5/22

(52) U.S. Cl. 351/153

(57) ABSTRACT

An eyeglass with an elastic element and an assembly method thereof are disclosed. The eyeglass with an elastic element include a lens frame set with at least one lens, a pair of temples pivotally connected to two opposite ends of the lens frame, respectively, and at least one elastic element provided at a pivotally connected portion of the lens frame and the temples. The eyeglass is characterized in that the elastic element is formed of a high polymer material so as to provide a restoring force when the temples are biased outwards.

### BACKGROUND OF THE INVENTION

1. Technical Field

The present invention relates to an eyeglass, and more particularly, to the eyeglass with an elastic element and an assembly method thereof.

2. Description of Related Art

Nowadays, an eyeglass designed to serve a variety of purposes are almost indispensable in our daily lives. For example, an eyeglass can serve practical purposes of correcting nearsightedness, farsightedness or other defects of vision. An eyeglass can also be function-oriented and be as diversified as industrial goggles, sunglasses and wind-shielding eyeglasses, to name only a few. Besides, there are various styling eyeglasses developed in pursuit of beauty and fashion. The design of eyeglass is usually based on the most common head shape of the time, so that lens frames and temples thus designed may have the most appropriate widths and lengths for general users. However, such compromising designs cannot satisfy the need of every user. On the other hand, if eyeglasses are customized to suit wearers' head shapes individually, the cost could be staggering. Hence, structures of eyeglass have been continuously improved and innovated, with the aim that eyeglass can be adjusted as appropriate to adapt to a wearer's inherent head shape conditions, in order to increase the practicality and convenience of eyeglass.

In order to make an eyeglass adaptable to different head widths, U.S. Pat. No. 5,400,090 mentions a connecting structure of eyeglass having spring-loaded temples as a background, as shown in FIG. 1A, wherein the connecting structure comprises a hinge 10, a U-shaped member 11, a compression spring 12 and a rivet pin 13. The aforesaid components are disposed in a tunnel 141 formed at a front end of a temple 14, before a screw is screwed into a thread hole 111 of the U-shaped member 11 to secure the aforesaid components in the tunnel 141. Referring to FIGS. 1B and 1C, when the temple 14 is biased outwards from a lens frame 15 and forms therewith an angle greater than 90°, the U-shaped member 11 secured to the temple 14 slides along the hinge 10 and compresses the compression spring 12 towards a rivet head 131 of the rivet pin 13, thereby allowing the temple 14 to be biased outwards over 90° without being disengaged from the lens frame 15. However, the prior art structure is complicated and difficult to assemble, which not only increases production and assembly costs significantly, but may also impair product competitiveness. Moreover, assembly, replacement or disassembly of such a complicated structure is a time-consuming, laborious and inefficient process that cannot be done without tools. Furthermore, the components mentioned above are mostly made of metal and therefore add to the weight of the assembled eyeglasses considerably. As a result, a user may feel uncomfortable after wearing the eyeglass for a long time.

### BRIEF SUMMARY OF THE INVENTION

In order to solve the aforesaid problems, it is a primary objective of the present invention to provide an eyeglass having an elastic element, wherein the eyeglass is more simply configured to reduce the difficulty and time involved in assembly, replacement or disassembly of the eyeglass.

Another objective of the present invention is to provide an eyeglass having an elastic element, wherein the eyeglass is more simply structured to decrease production and assembly costs significantly.

Still another objective of the present invention is to provide an eyeglass having an elastic element, wherein the elastic element is formed of a high polymer material and has a relatively light weight, so as to lower a total weight of the assembled eyeglass.

A further objective of the present invention is to provide an eyeglass having an elastic element, wherein the elastic element is formed of a high polymer material and therefore incurs a lower material cost.

Yet another objective of the present invention is to provide an eyeglass having an elastic element, wherein the elastic element is formed of a high polymer material, preferably polyoxymethylene, which is highly resistant to fatigue and therefore suitable for long-term use.

To achieve these objectives, the present invention provides an eyeglass, and more particularly, an eyeglass having an elastic element and an assembly method thereof. The eyeglass having an elastic element comprise a lens frame set with at least one lens; a pair of temples pivotally connected to two opposite ends of the lens frame, respectively; and at least one elastic element provided at a pivotally connected portion of the lens frame and the temples. The eyeglass is characterized in that the elastic element is formed of a high polymer material so as to provide a restoring force when the temples are biased outwards.

Since the elastic element of the present invention is interposed between the lens frame and the temples, when the temples are biased outwards by an external force, a protruding block formed at an end of the lens frame or each of the temples will be pushed inwards by the principle of leverage, thereby deforming the elastic element, which, in turn, generates a restoring force. Therefore, when the temples are pushed outwards to a particular angle so as to touch the lens frame, the angles to which the temples can be pushed outwards are constrained. As soon as the external force acting on the temples is removed, the resilient restoring force of the elastic element allows the temples to resume their original positions.

With a simple structure that can be easily assembled, replaced or disassembled, the present invention facilitating decreasing the time and manpower required for the assembly, replacement or disassembly operation, significantly reducing production and assembly costs and enhancing product competitiveness, thereby increasing economic efficiency. Besides, the elastic element of the present invention is formed of a high polymer material, such as polyoxymethylene (POM), plastic and rubber, which is relatively lighter weight than the conventionally used metal material. Hence, the total weight of the assembled eyeglass can be considerably reduced, so that the eyeglass can be worn more comfortably for a long time. Furthermore, as the high polymer material has a lower raw material cost than metal material does, the present invention also serves to reduce material cost. It should be noted that, among all the high polymer materials, polyoxymethylene is the most preferable material for use with the present invention because it has a higher resistance to fatigue and is therefore suitable for long-term use.

### BRIEF DESCRIPTION OF THE SEVERAL VIEWS OF THE DRAWINGS

The invention as well as a preferred mode of use, further objectives and advantages thereof will best be understood by reference to the following detailed description of illustrative embodiments when read in conjunction with the accompanying drawings, wherein:

FIGS. 1A to 1C are schematic drawings of a connecting structure of eyeglass having spring-loaded temples according to the prior art;

FIGS. 2A to 2C are schematic drawings of elastic elements according to different embodiments of the present invention;

FIG. 3 is a schematic drawing showing an eyeglass/elastic element assembly method according to an embodiment of the present invention;

FIG. 4 is a schematic drawing showing an eyeglass/elastic element assembly method according to another embodiment of the present invention;

FIG. 5 is a schematic drawing showing an eyeglass/elastic element assembly method according to yet another embodiment of the present invention;

FIGS. 6A and 6B are schematic drawings showing an eyeglass/elastic element assembly method according to still another embodiment of the present invention; and

FIGS. 7A and 7B are schematic drawings showing an eyeglass/elastic element assembly method according to a further embodiment of the present invention.

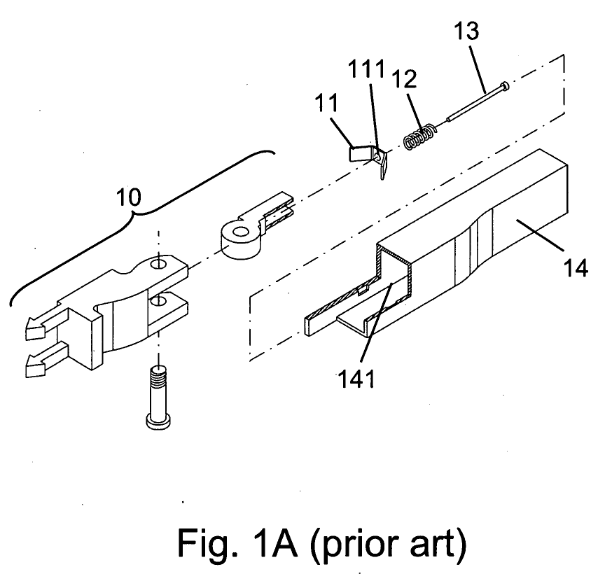

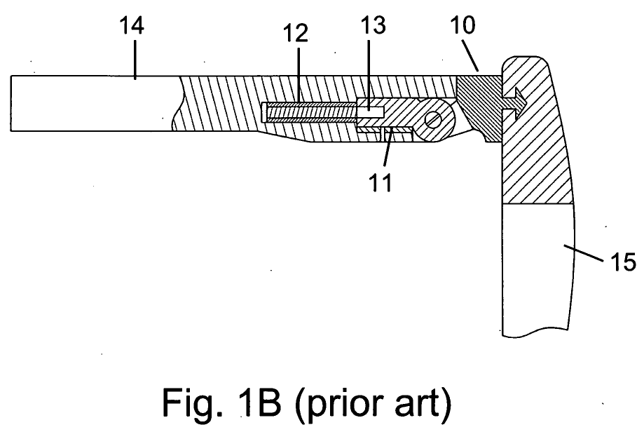

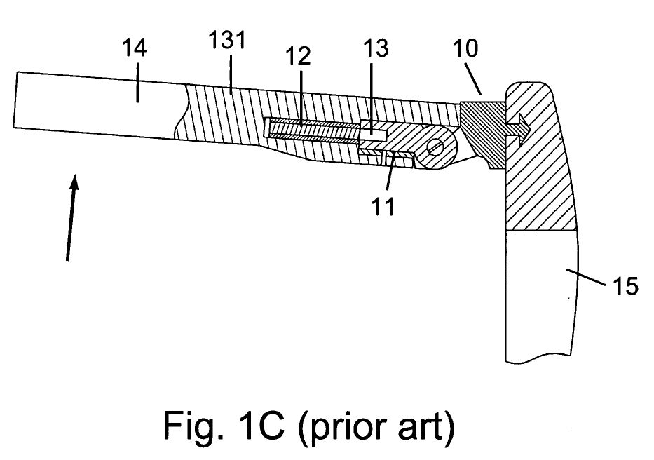

### DETAILED DESCRIPTION OF THE INVENTION

The present invention relates to an eyeglass, and more particularly, to the eyeglass having an elastic element, and an assembly method thereof. Since the production or processing procedures of eyeglass employed in the present invention can be achieved by existing techniques, a detailed description of such procedures is omitted herein. Besides, the drawings referred to hereunder are not drawn according to actual dimensions because they are intended only to demonstrate features of the present invention schematically.

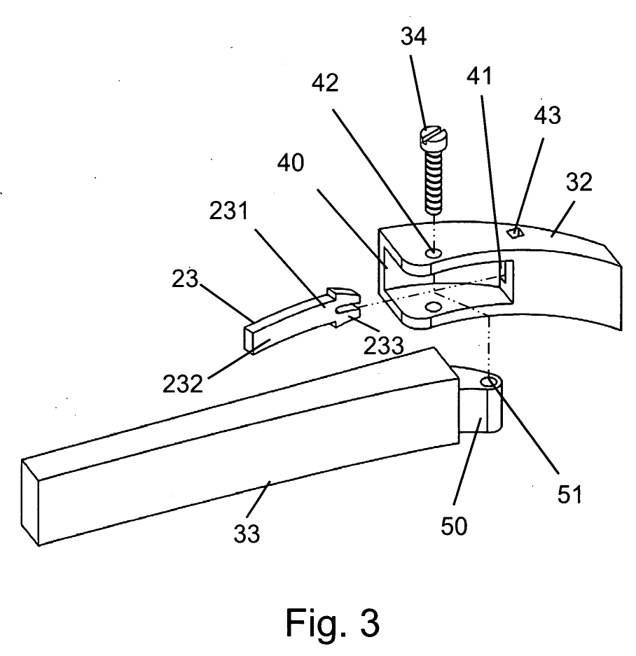

Referring to FIG. 3, which is a schematic view of eyeglass having an elastic element according to a preferred embodiment of the present invention, the eyeglass having the elastic element comprise at least one lens, a frame body and at least one elastic element 23. The frame body comprises a lens frame 32 to be set with the lens, and at least one pair of temples 33 pivotally connected to two opposite ends of the lens frame 32, respectively. The lens frame 32 or each of the temples 33 has at least one recess 40 for accommodating the elastic element 23, wherein the elastic element 23 is formed of a high polymer material, such as polyoxymethylene (POM), plastic and rubber. The elastic element 23 is disposed between the lens frame 32 and each of the temples 33, so as to provide a restoring force when the temples 33 are biased outwards. Each of the temples 33 is secured to the lens frame 32 by a fastener 34. The elastic element 23 can also be secured to the lens frame 32 or each of the temples 33 by a fastener (not shown), or by engaging with the lens frame 32 or each of the temples 33. Alternatively, the elastic element 23 can be integrally formed with the lens frame 32 or each of the temples 33.

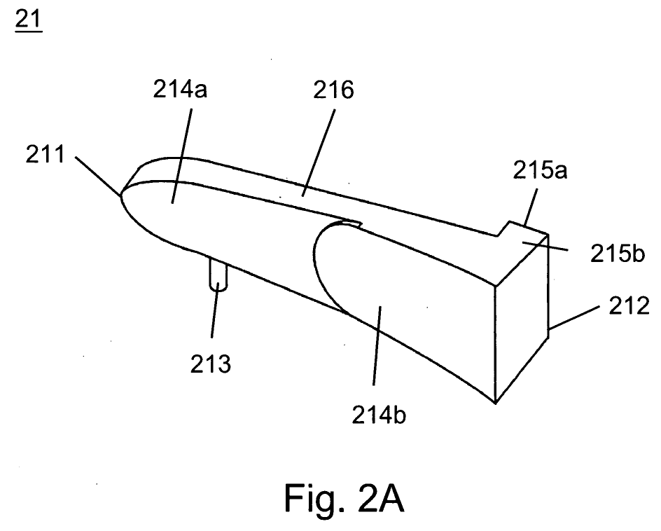

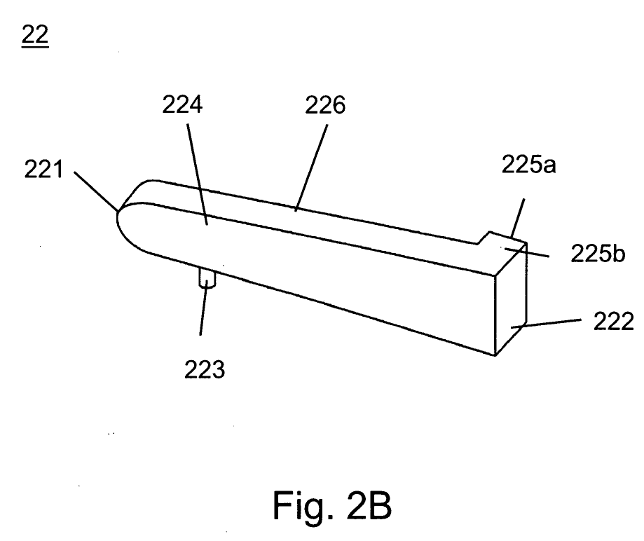

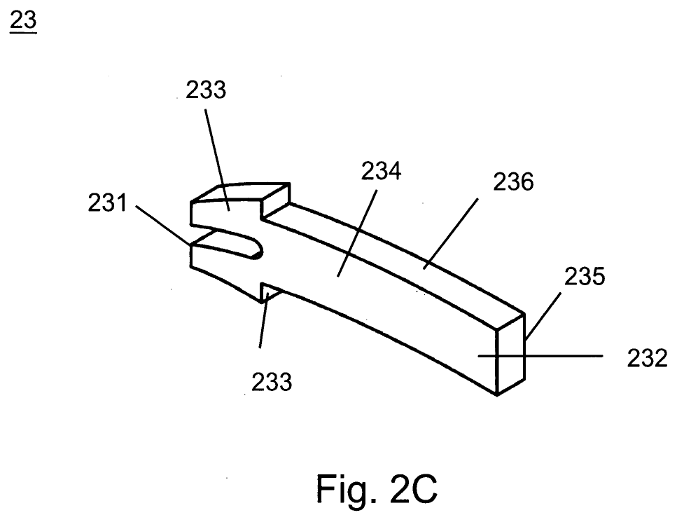

FIG. 2A is a schematic view of an elastic element according to a preferred embodiment of the present invention. Therein, an elastic element 21 is shaped as a generally flat and relatively thin block and has a first end portion 211 and a second end portion 212 opposite to the first end portion 211, wherein one of the first end portion 211 and the second end portion 212 is provided with at least one tenon 213. A width of the elastic element 21 may increase from the first end portion 211 towards the second end portion 212 or vice versa, so that the elastic element 21 has a substantially triangular shape. Meanwhile, a thickness of the elastic element 21 may increase from the first end portion 211 towards the second end portion 212 or vice versa, or remain constant between the first and second end portions 211 and 212, so that an edge 216 of the elastic element 21 may have a varying or uniform thickness. The elastic element 21 has at least one flat surface 214a, which is formed thereon with a raised, curved surface 214b. In addition, at least one engaging portion 215a is provided on one of the first end portion 211 and the second end portion 212 that is not provided with the tenon 213, wherein the engaging portion 215a has a projecting portion 215b formed on a reverse side of the elastic element 21 in relation to the flat surface 214a or to the curved surface 214b. The elastic element 21 is formed of a high polymer material, such as polyoxymethylene (POM), plastic and rubber.

FIG. 2B is a schematic view of an elastic element according to another preferred embodiment of the present invention. Therein, an elastic element 22 is shaped as a generally flat and relatively thin block and has a first end portion 221 and a second end portion 222 opposite to the first end portion 221, wherein one of the first end portion 221 and the second end portion 222 is provided with at least one tenon 223. A width of the elastic element 22 may increase from the first end portion 221 towards the second end portion 222 or vice versa, so that the elastic element 22 is substantially triangular in shape. Meanwhile, a thickness of the elastic element 22 may increase from the first end portion 221 towards the second end portion 222 or vice versa, or remain constant between the first and second end portions 221 and 222, so that an edge 226 of the elastic element 22 may have a varying or uniform thickness. The elastic element 22 has a totally flat surface 224. In addition, at least one engaging portion 225a is provided on one of the first end portion 221 and the second end portion 222 that is not provided with the tenon 223, wherein the engaging portion 225a has a projecting portion 225b formed on a reverse side of the elastic element 22 in relation to the flat surface 224. The elastic element 22 is formed of a high polymer material, such as polyoxymethylene (POM), plastic and rubber.

FIG. 2C is a schematic view of an elastic element according to still another preferred embodiment of the present invention. Therein, an elastic element 23 is shaped as a generally flat and relatively thin block and has a first end portion 231 and a second end portion 232 opposite to the first end portion 231, wherein one of the first end portion 231 and the second end portion 232 is provided with at least one hook 233. A width of the elastic element 23 is constant between the first end portion 231 and the second end portion 232. On the other hand, a thickness of the elastic element 23 may increase from the first end portion 231 towards the second end portion 232 or vice versa, or remain constant between the first and second end portions 231 and 232, so that an edge 236 of the elastic element 23 may have a varying or uniform thickness. The elastic element 23 has at least one flat surface 234. In addition, at least one engaging portion 235 is provided on a reverse side of the elastic element 23 in relation to the flat surface 234. The elastic element 23 is formed of a high polymer material, such as polyoxymethylene (POM), plastic and rubber.

FIG. 3 is a schematic view of a lens frame according to one preferred embodiment of the present invention. Therein, a lens frame 32 has at least one recess 40, which is formed on an inner side thereof with an inner cavity 41 and at least one fastening hole 42. The inner cavity 41 is further formed on an inner side thereof with at least one through hole 43 or engaging groove.

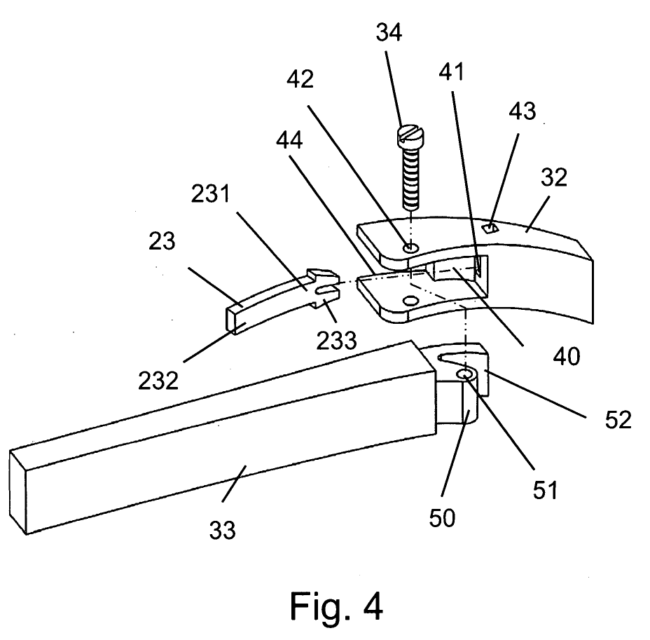

FIG. 4 is a schematic view of a lens frame according to another preferred embodiment of the present invention. Therein, a lens frame 32 has at least one recess 40, which is formed on an inner side thereof with an inner cavity 41 and at least one fastening hole 42. The recess 40 has a hollow portion 44 formed on a side thereof, and the inner cavity 41 is further formed on an inner side thereof with at least one through hole 43 or engaging groove.

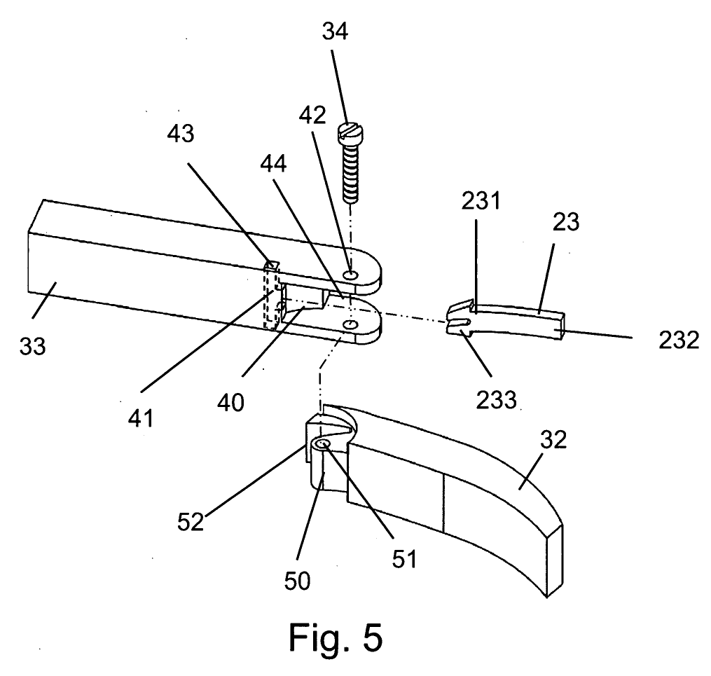

FIG. 5 is a schematic view of a lens frame according to still another preferred embodiment of the present invention. Therein, a lens frame 32 is provided on each of two opposite ends thereof with at least one protruding portion 50 formed with at least one fastening hole 51. The protruding portion 50 is further formed with at least one protruding block 52.

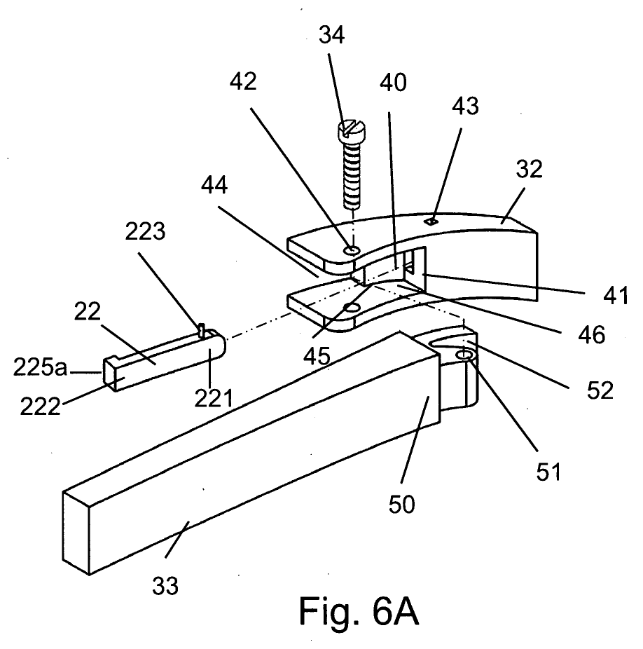

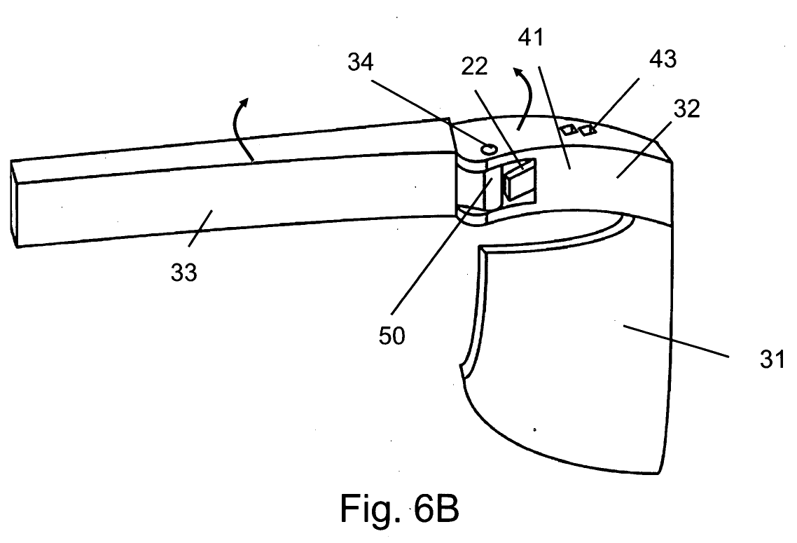

FIG. 6A is a schematic view of a lens frame according to yet another preferred embodiment of the present invention. Therein, a lens frame 32 has at least one recess 40, which is formed on an inner side thereof with an inner cavity 41 and at least one fastening hole 42. The recess 40 has a hollow portion 44 formed on a side thereof, and the inner cavity 41 is further formed on an inner side thereof with at least one through hole 43 or engaging groove. The recess 40 has an opening 45 and a bottom 46, wherein the opening 45 is wider than the bottom 46.

As shown in FIG. 6A, an elastic element 22 has a first end portion 221 and a second end portion 222 opposite to the first end portion 221, wherein the first end portion 221 is narrower than the second end portion 222. When the elastic element 22 is disposed in the recess 40, which is pre-formed with a portion having a same width as the elastic element 22, the elastic element 22 is engaged with the opening 45 and thereby secured in the recess 40. Meanwhile, the elastic element 22 can be partially secured in the inner cavity 41.

According to another preferred embodiment of the lens frame of the present invention, the lens frame is integrally formed with the elastic element.

According to still another preferred embodiment of the lens frame of the present invention, the lens frame is integrally formed with the lens, and the lens is formed with at least one fastening hole for pivotally connecting with the temples.

According to a preferred embodiment of a lens supporting structure of the present invention, the lens supporting structure has an end to be pivotally connected with a temple, and an opposite end that is not pivotally connected with the temple but affixed to a lens by clamping or by securing with a fastener, thereby forming a frameless eyeglass.

FIG. 3 is a schematic view of a temple according to a preferred embodiment of the present invention. Therein, a temple 33 is provided at an end thereof with at least one protruding portion 50, which is formed with at least one fastening hole 51.

FIG. 4 is a schematic view of a temple according to another preferred embodiment of the present invention. Therein, a temple 33 is provided at an end thereof with at least one protruding portion 50, which is formed with at least one fastening hole 51. In addition, the protruding portion 50 is further formed with at least one protruding block 52.

FIG. 5 is a schematic view of a temple according to yet another preferred embodiment of the present invention. Therein, a temple 33 has at least one recess 40, which is formed on an inner side thereof with an inner cavity 41 and at least one fastening hole 42. The recess 40 has a hollow portion 44 formed on a side thereof, and the inner cavity 41 is further formed on an inner side thereof with at least one through hole 43 or engaging groove.

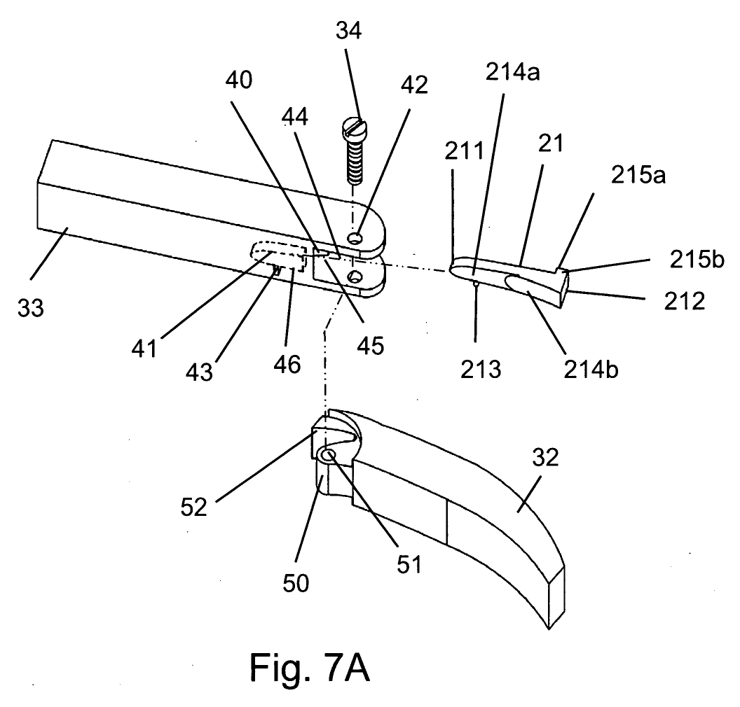

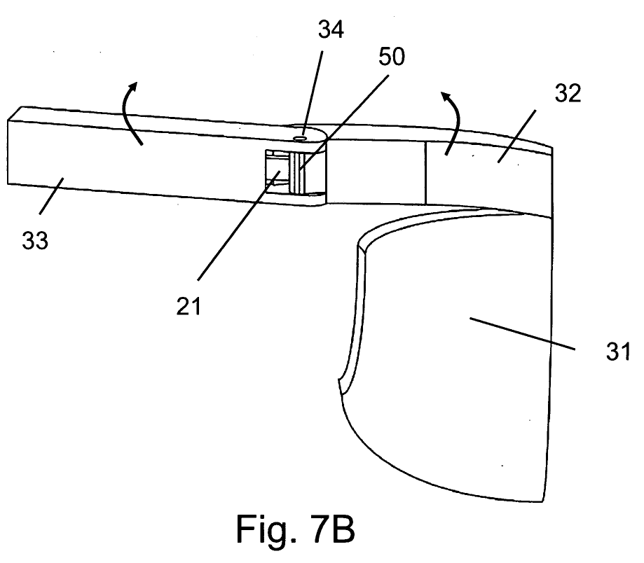

FIG. 7A is a schematic view of a temple according to still another preferred embodiment of the present invention. Therein, a temple 33 has at least one recess 40, which is formed on an inner side thereof with an inner cavity 41 and at least one fastening hole 42. The recess 40 has a hollow portion 44 formed on a side thereof, and the inner cavity 41 is further formed on an inner side thereof with at least one through hole 43 or engaging groove. In addition, the recess 40 has an opening 45 and a bottom 46, wherein the opening 45 is wider than the bottom 46.

As shown in FIG. 7A, an elastic element 21 has a flat surface 214a, which is formed thereon with a raised, curved surface 214b. When the elastic element 21 is disposed in the recess 40, the curved surface 214b is engaged with the opening 45 and juts out partially therefrom, so as to produce an engaging effect.

According to another preferred embodiment of the temple of the present invention, the temple is integrally formed with the elastic element.

FIG. 3 is a schematic drawing showing an eyeglass/elastic element assembly method according to a preferred embodiment of the present invention, the assembly method comprising the following steps. Firstly, a lens frame 32 is provided. The lens frame 32 is constructed, on each of two opposites ends thereof, with at least one recess 40, which is formed on an inner side thereof with an inner cavity 41 and at least one first fastening hole 42. The inner cavity 41 is further formed on an inner side thereof with at least one through hole 43. Secondly, a temple 33 is provided. The temple 33 is constructed, at an end thereof, with at least one protruding portion 50 formed with at least one second fastening hole 51. Thirdly, an elastic element 23 made of a high polymer material is provided, wherein the high polymer elastic element 23 has a first end portion 231 formed with at least one hook 233, and a second end portion 232 opposite to the first end portion 231, and the high polymer material can be polyoxymethylene (POM), plastic, rubber and so on. Fourthly, the first end portion 231 of the high polymer elastic element 23 is inserted into the inner cavity 41 of a corresponding one of the recesses 40 in the lens frame 32, so that the high polymer elastic element 23 is disposed inside the corresponding recess 40. As a result, the hook 233 of the first end portion 231 is engaged with the through hole 43 of the corresponding recess 40 and juts out partially therefrom, thereby producing an engaging effect. Meanwhile, the second end portion 232 of the high polymer elastic element 23 presses against the temple 33 or forms a gap therewith, so as to provide different effects of force application. Fifthly, the protruding portion 50 of the temple 33 is inserted into the corresponding recess 40 of the lens frame 32, so that the first fastening hole 42 of the corresponding recess 40 is aligned with the second fastening hole 51, while the high polymer elastic element 23 is disposed between the lens frame 32 and the temple 33. Finally, a fastener 34 is provided to fasten the first fastening hole 42 of the corresponding recess 40 with the second fastening hole 51, thereby securing the temple 33 to the lens frame 32.

FIG. 4 is a schematic drawing showing an eyeglass/elastic element assembly method according to another preferred embodiment of the present invention, wherein the assembly method comprises the following steps. Firstly, a lens frame 32 is provided, wherein the lens frame 32 is constructed, on each of two opposites ends thereof, with at least one recess 40, which is formed on an inner side thereof with a hollow portion 44, an inner cavity 41 and at least one first fastening hole 42. The inner cavity 41 is further formed on an inner side thereof with at least one through hole 43. Secondly, a temple 33 is provided, wherein the temple 33 is constructed, at an end thereof, with at least one protruding portion 50 formed with at least one protruding block 52 and a second fastening hole 51. Thirdly, an elastic element 23 made of a high polymer material is provided, wherein the high polymer elastic element 23 has a first end portion 231 formed with at least one hook 233, and a second end portion 232 opposite to the first end portion 231, and the high polymer material can be polyoxymethylene (POM), plastic, rubber and so on. Fourthly, the first end portion 231 of the high polymer elastic element 23 is inserted into the inner cavity 41 of a corresponding one of the recesses 40 in the lens frame 32, so that the high polymer elastic element 23 is disposed inside the corresponding recess 40. As a result, the hook 233 of the first end portion 231 is engaged with the through hole 43 of the corresponding recess 40 and juts out partially therefrom, thereby producing an engaging effect. Meanwhile, the second end portion 232 of the high polymer elastic element 23 presses against the temple 33 or forms a gap therewith, so as to provide different effects of force application. Fifthly, the protruding portion 50 of the temple 33 is inserted into the corresponding recess 40 of the lens frame 32, so that the protruding block 52 is disposed inside the hollow portion 44 of the corresponding recess 40 while the first fastening hole 42 of the corresponding recess 40 is aligned with the second fastening hole 51. In consequence, the high polymer elastic element 23 is disposed between the lens frame 32, the temple 33 and the protruding block 52. Finally, a fastener 34 is provided to fasten the first fastening hole 42 of the corresponding recess 40 with the second fastening hole 51, thereby securing the temple 33 to the lens frame 32. When the temple 33 is biased outwards by an external force, the protruding block 52 at the end of the temple 33 is pushed inwards by the principle of leverage, so that the high polymer elastic element 23 is deformed and generates a restoring force. Therefore, when the temple 33 is pushed outwards to a particular angle so as to touch the lens frame 32, the angle to which the temple 33 can be pushed outwards is constrained. As soon as the external force acting on the temple 33 is released, the resilient restoring force of the elastic element 23 allows the temple 33 to resume its original position.

FIG. 5 is a schematic drawing showing an eyeglass/elastic element assembly method according to yet another preferred embodiment of the present invention, the assembly method comprising the following steps. Firstly, a temple 33 is provided. The temple 33 is constructed, at an end thereof, with at least one recess 40, which is formed on an inner side thereof with a hollow portion 44, an inner cavity 41 and at least one first fastening hole 42. The inner cavity 41 is further formed on an inner side thereof with at least one through hole 43. Secondly, a lens frame 32 is provided, wherein the lens frame 32 is constructed, on each of two opposite ends thereof, with at least one protruding portion 50 formed with at least one protruding block 52 and a second fastening hole 51. Thirdly, an elastic element 23 made of a high polymer material is provided, wherein the high polymer elastic element 23 has a first end portion 231 formed with at least one hook 233, and a second end portion 232 opposite to the first end portion 231, and the high polymer material can be polyoxymethylene (POM), plastic, rubber and so on. Fourthly, the first end portion 231 of the high polymer elastic element 23 is inserted into the inner cavity 41 of the recess 40 in the temple 33, so that the high polymer elastic element 23 is disposed inside the recess 40. As a result, the hook 233 of the first end portion 231 is engaged with the through hole 43 and juts out partially therefrom, thereby producing an engaging effect. Meanwhile, the second end portion 232 of the high polymer elastic element 23 presses against the lens frame 32 or forms a gap therewith, so as to provide different effects of force application. Fifthly, a corresponding one of the protruding portions 50 on the lens frame 32 is inserted into the recess 40 of the temple 33, so that the protruding block 52 of the corresponding protruding portion 50 is disposed inside the hollow portion 44 while the first fastening hole 42 is aligned with the second fastening hole 51 of the corresponding protruding portion 50. Consequently, the high polymer elastic element 23 is disposed between the lens frame 32, the temple 33 and the protruding block 52 of the corresponding protruding portion 50. Finally, a fastener 34 is provided to fasten the first fastening hole 42 with the second fastening hole 51 of the corresponding protruding portion 50, thereby securing the temple 33 to the lens frame 32. When the temple 33 is biased outwards by an external force, the protruding block 52 of the corresponding protruding portion 50 at one of the two opposite ends of the lens frame 32 is pushed inwards by the principle of leverage, so that the high polymer elastic element 23 is deformed and generates a restoring force. Therefore, when the temple 33 is pushed outwards to a particular angle so as to touch the lens frame 32, the angle to which the temple 33 can be pushed outwards is constrained. As soon as the external force acting on the temple 33 is removed, the resilient restoring force of the elastic element 23 allows the temple 33 to resume its original position.

FIG. 6A is a schematic drawing showing an eyeglass/elastic element assembly method according to still another preferred embodiment of the present invention, wherein the assembly method comprises the following steps. Firstly, a lens frame 32 is provided. The lens frame 32 is constructed, on each of two opposite ends thereof, with at least one recess 40, which is formed on an inner side thereof with a hollow portion 44, an inner cavity 41 and at least one first fastening hole 42. The inner cavity 41 is further formed on an inner side thereof with at least one through hole 43. Secondly, a temple 33 is provided, wherein the temple 33 is constructed, at an end thereof, with at least one protruding portion 50 formed with at least one protruding block 52 and a second fastening hole 51. Thirdly, an elastic element 22 made of a high polymer material is provided, wherein the high polymer elastic element 22 has a first end portion 221 formed with at least one tenon 223, and a second end portion 222 which is opposite to the first end portion 221 and has an engaging portion 225a. The high polymer material can be polyoxymethylene (POM), plastic, rubber and so on. Fourthly, the first end portion 221 of the high polymer elastic element 22 is inserted into the inner cavity 41 of a corresponding one of the recesses 40 in the lens frame 32, so that the high polymer elastic element 22 is disposed inside the corresponding recess 40. As a result, the tenon 223 is engaged with the through hole 43 of the corresponding recess 40 and juts out partially therefrom, thereby producing an engaging effect. Meanwhile, the second end portion 222 of the high polymer elastic element 22 presses against the temple 33 or forms a gap therewith, so as to provide different effects of force application. Fifthly, the protruding portion 50 of the temple 33 is inserted into the corresponding recess 40 of the lens frame 32, so that the protruding block 52 is disposed inside the hollow portion 44 of the corresponding recess 40 while the first fastening hole 42 of the corresponding recess 40 is aligned with the second fastening hole 51. In consequence, the high polymer elastic element 22 is interposed between the lens frame 32, the temple 33 and the protruding block 52. Finally, a fastener 34 is provided to fasten the first fastening hole 42 of the corresponding recess 40 with the second fastening hole 51, thereby securing the temple 33 to the lens frame 32. When the temple 33 is biased outwards by an external force, as shown in FIG. 6B, the protruding block 52 at the end of the temple 33 is pushed inwards by the principle of leverage, so that the engaging portion 225a of the high polymer elastic element 22 is deformed and generates a restoring force. Therefore, when the temple 33 is pushed outwards to a particular angle so as to touch the lens frame 32, the angle to which the temple 33 can be pushed outwards is constrained. As soon as the external force acting on the temple 33 is removed, the resilient restoring force of the engaging portion 225a of the high polymer elastic element 22 allows the temple 33 to resume its original position.

In the present preferred embodiment, if the first end portion 221 has one and only one tenon 223 and each of the recesses 40 is formed with two through holes 43, the tenon 223 can be engaged with either of the two through holes 43 of a corresponding one of the recesses 40 and juts out partially therefrom, so as to provide different levels of restoring forces when the temple 33 is biased outwards.

FIG. 7A is a schematic drawing showing an eyeglass/elastic element assembly method according to a further preferred embodiment of the present invention, wherein the assembly method comprises the following steps. Firstly, a temple 33 is provided. The temple 33 is constructed, at an end thereof, with at least one recess 40, which is formed on an inner side thereof with a hollow portion 44, an inner cavity 41 and at least one first fastening hole 42. The inner cavity 41 is further formed on an inner side thereof with at least one through hole 43. Secondly, a lens frame 32 is provided, wherein the lens frame 32 is constructed, on each of two opposite ends thereof, with at least one protruding portion 50 formed with at least one protruding block 52 and a second fastening hole 51. Thirdly, an elastic element 21 made of a high polymer material is provided, wherein the high polymer elastic element 21 has a first end portion 211 formed with at least one tenon 213, and a second end portion 212 which is opposite to the first end portion 211 and has an engaging portion 215a. The high polymer material can be polyoxymethylene (POM), plastic, rubber and so on. Fourthly, the first end portion 211 of the high polymer elastic element 21 is inserted into the inner cavity 41 of the recess 40 in temple 33, so that the high polymer elastic element 21 is disposed inside the recess 40. As a result, the tenon 213 is engaged with the through hole 43 and juts out partially therefrom, thereby producing an engaging effect. Meanwhile, the second end portion 212 of the elastic element 21 presses against the lens frame 32 or forms a gap therewith, so as to provide different effects of force application. Fifthly, a corresponding one of the protruding portions 50 of the lens frame 32 is inserted into the recess 40 of the temple 33, so that the protruding block 52 of the corresponding protruding portion 50 is disposed inside the hollow portion 44 while the first fastening hole 42 is aligned with the second fastening hole 51 of the corresponding protruding portion 50. Consequently, the high polymer elastic element 21 is interposed between the lens frame 32, the temple 33 and the protruding block 52. Finally, a fastener 34 is provided to fasten the first fastening hole 42 with the second fastening hole 51 of the corresponding protruding portion 50, thereby securing the temple 33 to the lens frame 32. When the temple 33 is biased outwards by an external force, as shown in FIG. 7B, the protruding block 52 of the corresponding protruding portion 50 on one of the two ends of the lens frame 32 is pushed inwards by the principle of leverage, so that the engaging portion 215a of the high polymer elastic element 21 is deformed and generates a restoring force. Therefore, when the temple 33 is pushed outwards to a particular angle so as to touch the lens frame 32, the angle to which the temple 33 can be pushed outwards is constrained. As soon as the external force acting on the temple 33 is removed, the resilient restoring force of the engaging portion 215a of the high polymer elastic element 21 allows the temple 33 to resume its original position.

In the present preferred embodiment, if the first end portion 221 has one and only one tenon 213 and the recess 40 is formed with two through holes 43, the tenon 213 can be engaged with either of the two through holes 43 and juts out partially therefrom, so as to provide different levels of restoring forces when the temple 33 is biased outwards.

The present invention provides an improvement over the prior art. Since the high polymer elastic element of the present invention is interposed between the lens frame and the temple, when the temple is biased outwards by an external force, the protruding block at an end of the lens frame or the temple will be pushed inwards by the principle of leverage, thereby deforming the high polymer elastic element, which, in turn, generates a restoring force. Therefore, when the temple is pushed outwards to a particular angle so as to touch the lens frame, the angle to which the temple can be pushed outwards is constrained. As soon as the external force acting on the temple is removed, the resilient restoring force of the high polymer elastic element allows the temple to resume its original position.

With a simple structure that can be easily assembled, replaced or disassembled, the present invention can decrease the time and manpower required for the assembly, replacement or disassembly operation, significantly reduce production and assembly costs and enhance product competitiveness, thereby increasing economic efficiency. Besides, the elastic element of the present invention is formed of a high polymer material, such as polyoxymethylene (POM), plastic and rubber, which has a lighter weight than the conventionally used metal material. Hence, the total weight of the assembled eyeglass can be considerably reduced, allowing the eyeglass to be worn more comfortably for a long time. Furthermore, as the high polymer material has a lower raw material cost than metal material, the present invention also contributes to reducing material cost. It should be noted that, of all the high polymer materials, polyoxymethylene is the most preferable material for use with the present invention because it has a higher resistance to fatigue and is therefore suitable for long-term use.

The present invention has been described with reference to preferred embodiments thereof, which are provided for illustrative purposes only and not intended to limit the scope of the present invention. Moreover, as the contents disclosed herein should be readily understood and can be implemented by a person skilled in the art, all equivalent changes or modifications which do not depart from the spirit of the present invention should be encompassed by the appended claims.

What is claimed is:

1. An eyeglass comprising a lens frame set with at least one lens, a pair of temples pivotally connected to two opposite ends of said lens frame, respectively, and at least one elastic element provided at a pivotally connected portion of said lens frame and said temples, said eyeglass being characterized in that:
said elastic element is formed of a high polymer material.

2. The eyeglass according to claim 1, wherein one of said lens frame is provided with at least one recess for receiving said elastic element.

3. The eyeglass according to claim 1, wherein one of said temples is provided with at least one recess for receiving said elastic element.

4. The eyeglass according to claim 1, wherein said elastic element is integrally formed with one of said lens frame.

5. The eyeglass according to claim 1, wherein said elastic element is integrally formed with one of said temples.

6. The eyeglass according to claim 1, wherein said high polymer material is selected from the group consisting of the following: polyoxymethylene (POM), plastic and rubber.

7. The eyeglass according to claim 1, wherein said elastic element has a first end portion and a second end portion opposite to said first end portion.

8. The eyeglass according to claim 7, wherein one of said first end portion and said second end portion has at least one hook.

9. The eyeglass according to claim 7, wherein one of said first end portion and said second end portion has at least one tenon.

10. The eyeglass according to claim 1, wherein said elastic element has at least one flat surface.

11. The eyeglass according to claim 10, wherein said flat surface has a raised, curved surface formed thereon.

12. The eyeglass according to claim 7, wherein one of said first end portion and said second end portion has at least one engaging portion.

13. The eyeglass according to claim 12, wherein said engaging portion has at least one projecting portion.

14. The eyeglass according to claim 3, wherein said recess has an opening and a bottom.

15. The eyeglass according to claim 14, wherein said opening of the recess is wider than said bottom of said recess.

16. The eyeglass according to claim 3, wherein said recess has an inner cavity formed on an inner side thereof.

17. The eyeglass according to claim 16, wherein said inner cavity has at least one through hole formed on an inner side thereof.

18. The eyeglass according to claim 3, wherein said recess has a hollow portion formed on one side thereof.

19. The eyeglass according to claim 3, wherein said recess has at least one engaging groove formed on one side thereof.

20. The eyeglass according to claim 1, wherein said lens frame is provided on each of the two opposite ends thereof with at least one protruding portion.

21. The eyeglass according to claim 1, wherein each of said temples is provided at an end thereof with at least one protruding portion.

22. An eyeglass comprising a pair of lens supporting structures, a pair of temples and at least one elastic element, wherein each of said lens supporting structure has an end pivotally connected with a corresponding one of said temples, and another end of said lens supporting structure that is not pivotally connected with said temples but affixed to at least one said lens by clamping, and said elastic element is provided at a pivotally connected portion of said lens supporting structure and said temples, said eyeglass being characterized in that:
said elastic element is formed of a high polymer material.
